(19) United States
(12) Patent Application Publication
(10) Pub. No.: US 2026/0100223 A1
(43) Pub. Date: Apr. 9, 2026

(54) SRAM PHYSICAL UNCLONABLE FUNCTION WITH IMPROVED BIT ERROR RATE

(71) Applicant: Booz Allen Hamilton Inc., McLean, VA (US)

(72) Inventor: Randy W. MANN, Saugerties, NY (US)

(73) Assignee: Booz Allen Hamilton Inc., McLean, VA (US)

(21) Appl. No.: 19/347,012

(22) Filed: Oct. 1, 2025

Related U.S. Application Data
(60) Provisional application No. 63/704,275, filed on Oct. 7, 2024.

(51) Int. Cl. G11C 11/419; G06F 21/44; G11C 11/412; G11C 11/418

(52) U.S. Cl. CPC G11C 11/419; G06F 21/44; G11C 11/412; G11C 11/418

(57) ABSTRACT

An exemplary integrated circuit includes a memory array. In the array, each row includes a word line, and each column includes a pair of bit lines. A pre-charge circuit pre-charges the pair of bit lines for each bit line column to a primary operating voltage. A decoder asserts a pair of word lines located in one of the plural bit line columns of the memory array to select a pair of adjacent memory cells. A sense amplifier is connected between the pair of bit lines forming a first column of the plural columns and generates a binary output based on a difference between the read currents of the adjacent memory cells. A verification circuit is connected to determine whether current bit values stored in the adjacent memory cells read by the sense amplifier are consistent with predefined bit values written to the adjacent memory cells based on the binary output.

### RELATED APPLICATIONS

This application claims priority to U.S. Patent Application No. 63/704,275 filed on Oct. 7, 2024, the entire contents of which are hereby incorporated by reference.

### FIELD

The present disclosure relates generally to a memory circuit, and particularly to a static random access memory (SRAM) circuit with a physical unclonable function (PUF).

### BACKGROUND

SRAM PUF (Static Random-Access Memory Physical Unclonable Function) is a pioneering hardware security technology that utilizes the intrinsic physical variations found in the devices that comprise the SRAM cells to generate unique cryptographic keys. The SRAM PUF harnesses the natural variations in silicon manufacturing processes as the primary entropy source to produce keys that are virtually impossible to duplicate or predict. Because the SRAM devices are built using the same processes as CMOS logic, SRAM has become nearly ubiquitous memory in modern CMOS. This makes SRAM PUF a highly practical and secure method for protecting sensitive data and ensuring the authenticity of devices in various applications, from IoT devices to secure banking systems.

SRAM PUF works by exploiting the random electrical characteristics of SRAM cells when they are powered on. These characteristics are unique to each chip due to fundamental phenomena such as random dopant fluctuations (RDF) which result in atomic level differences that occur during the manufacturing process. As a result, each SRAM PUF implementation can generate a distinct and repeatable key, which can be used for secure authentication, encryption, random number generation and other cryptographic functions.

Current SRAM PUF approaches most commonly rely on the power up state of the SRAM array. Known SRAM PUF designs can present challenges in that bits are subject to aging such that negative bias temperature instability (NBTI) can skew the bits over time. In addition, the SRAM can encounter a noisy bit effect in which approximately 15-30% of bits to power up in a non-repeating state (noisy bits). Still further the bit error rate (BER) of known SRAM PUF designs can, over time, develop sensitivity to the power-up ramp rate, temperature, and voltage stability, and can also develop a dependency on the sense amplifier. Significant overhead is required to address these BER issues.

### SUMMARY

An exemplary integrated circuit is disclosed, comprising: a memory array having plural memory cells arranged in plural rows and plural bit line columns, each row is formed by a word line and each column is formed by a pair of bit lines, each memory cell including a pair of cross coupled inverters connected between a pair of access transistors, each access transistor is connected to one bit line of the pair of bit lines forming the bit line column, and each access transistor has a gate connected to the word line forming the row; a pre-charge circuit configured to pre-charge the pair of bit lines for each bit line column in the memory array to a primary operating voltage; a decoder configured to output a binary value for selecting each of the memory cells based on the pair of bit lines and the word line to which the memory cell is connected, the decoder being configured to assert a pair of word lines located in one of the plural bit line columns of the memory array to select a pair of adjacent memory cells; a sense amplifier connected between the pair of bit lines forming a first column of the plural columns, the sense amplifier configured to generate a binary output based on a difference between read currents of the pair of adjacent memory cells; and a verification circuit connected to receive the binary output from the sense amplifier and determine whether current bit values stored in the pair of adjacent memory cells are consistent with predefined bit values written to the pair of adjacent memory cells based on the binary output.

An exemplary method for authenticating an integrated circuit is disclosed, the integrated circuit having a memory array that includes plural memory cells arranged in plural rows and plural columns, each row is formed by a word line and each column is formed by a pair of bit lines, each memory cell including a pair of cross coupled inverters connected between a pair of access transistors, each access transistor is connected to one bit line of the pair of bit lines forming the column, and each access transistor has a gate connected to the word line forming the row; a decoder configured to output a binary value for selecting each of the memory cells based on the pair of bit lines and the word line to which the memory cell is connected; a sense amplifier connected between the pair of bit lines forming a column of the plural columns; and a pre-charge circuit connected to a primary voltage and to the pair of bit lines in each column, the method comprising: writing a pattern of bits into the plural memory cells the memory array; pre-charging, by the pre-charge circuit, a pair of bit lines forming each column in the memory array to a voltage level of the primary voltage; enabling a pair of word lines in the plural rows of the memory array; selecting one column of the plural columns in the memory array, wherein a pair of memory cells in the selected column are activated based on the enabled pair of word lines; comparing the pair of bit lines for the pair of activated memory cells for the selected column; enabling the sense amplifier connected to the pair of bit lines forming the selected column; reading a latched bit value at an output terminal of the sense amplifier; and determining whether latched bit value is consistent with a predefined bit values written to the pair of activated memory cells based on the binary value output by the sense amplifier.

### DESCRIPTION OF THE DRAWINGS

The scope of the present disclosure is best understood from the following detailed description of exemplary embodiments when read in conjunction with the accompanying drawings, wherein:

FIG. 1A illustrates an exemplary memory circuit in accordance with an exemplary embodiment of the present disclosure.

FIG. 1B illustrates a distribution in read current according to an exemplary embodiment of the present disclosure.

FIG. 2 illustrates a graph showing a resolution delay of a PUF SA in accordance with an exemplary embodiment of the present disclosure.

FIG. 3 illustrates a second memory circuit in accordance with an exemplary embodiment of the present disclosure.

FIG. 4 illustrates a schematic of an SRAM circuit in accordance with an exemplary embodiment of the present disclosure.

FIGS. 5A and 5B illustrate first schematic diagrams of a SRAM circuit with a multiplexer in accordance with an exemplary embodiment of the present disclosure.

FIG. 6 illustrates a second schematic diagram of an SRAM circuit with a multiplexer in accordance with an exemplary embodiment of the present disclosure.

FIG. 7 illustrates a method for authenticating the SRAM circuit of FIG. 1A in accordance with an exemplary embodiment of the present disclosure.

FIG. 8 illustrates a method 800 for authenticating an SRAM circuit of FIG. 3 in accordance with an exemplary embodiment of the present disclosure.

FIGS. 9A to 9C illustrate schematic diagrams of additional SRAM circuits in accordance with an exemplary embodiment of the present disclosure.

Further areas of applicability of the present disclosure will become apparent from the detailed description provided hereinafter. The detailed descriptions of exemplary embodiments described herein are intended for illustration purposes only and, therefore, are not intended to necessarily limit the scope of the disclosure.

### DETAILED DESCRIPTION

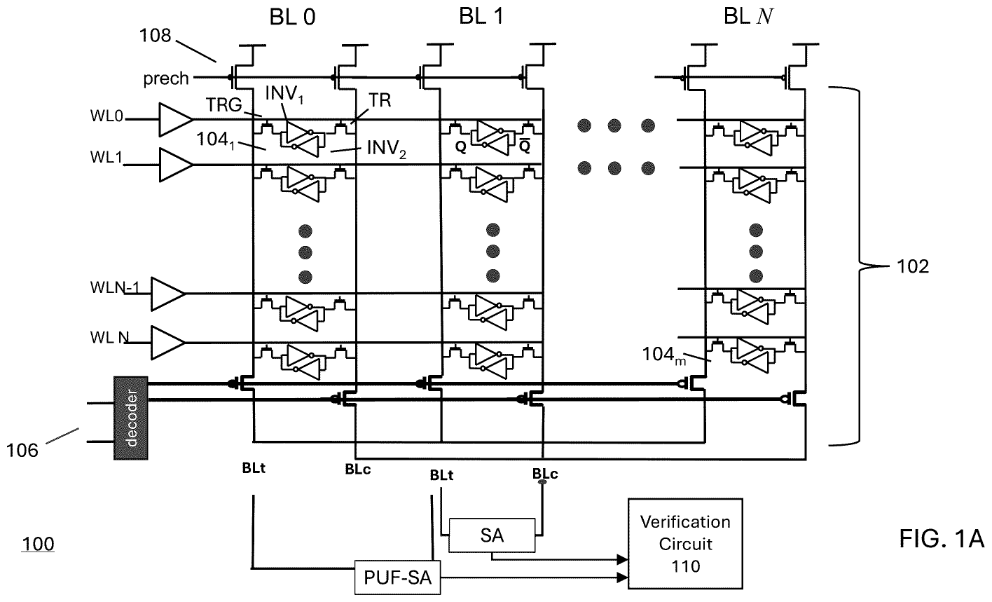

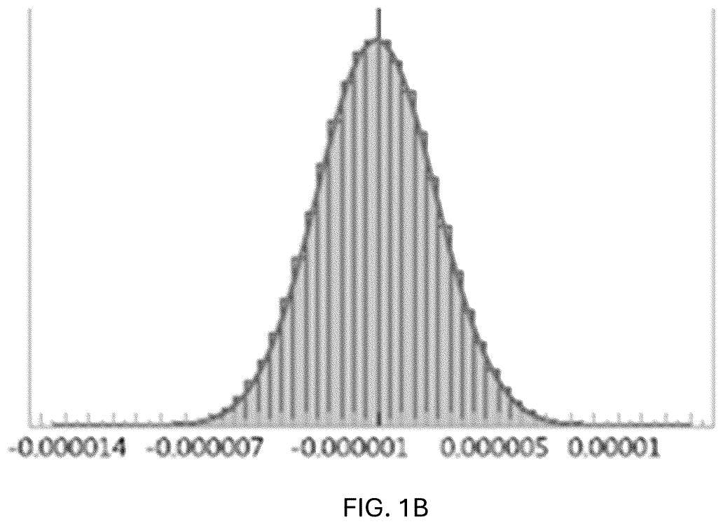

FIG. 1A illustrates an exemplary memory circuit in accordance with an exemplary embodiment of the present disclosure. Exemplary embodiments of a memory circuit, such as an SRAM PUF, disclosed herein can improve the BER of the PUF by relying on, in one exemplary embodiment, the mismatch in read current between two adjacent bits in the array and, in another exemplary embodiment, the mismatch in read current between two distinct bits in the local array. The improvement can be realized by utilizing SRAM adjacent read current mismatch as an entropy source, and a secondary sense amplifier (SA), which is added to the SRAM circuit as a complement to the known PUF sense amplifier. A predefined bit pattern is written to the array for the challenge and response operation. For example, the predefined bit pattern can include all ones (1s), a pattern of alternating 1s and zeroes (0s), or any other suitable bit pattern as desired. Once the memory array is coded with the predefined bit pattern, the bit lines (BLs) of the SRAM can be pre-charged high as in a read operation. Next, a specified word line(s) (WL) in the array can be asserted, and two BLs in adjacent bit cells can be evaluated by the PUF sense amp. According to exemplary embodiments of the present disclosure, the bit pattern is predefined so that the read current for two adjacent (or near adjacent/local array) array bits are sensed and compared. Because of the natural variation in read current within a bit or between two adjacent bits, the distribution in current will follow a Gaussian distribution. FIG. 1B illustrates a distribution in read current according to an exemplary embodiment of the present disclosure. As shown in FIG. 1B, a mismatch is defined as the delta in read current from a given drain/gate PD/PG within an SRAM cell to another PD/PG drain/gate in the same SRAM cell or another SRAM cell in the local array. For example, a 12 Mb SRAM the challenge/response bit pattern can be spatially random. The sensitivity of the sense amplifier governs the noisy bit effect, such that the sensitivity can be tuned to control percentage of noisy bits at power-up as desired. Because SRAM is used ubiquitously as an embedded memory in modern integrated circuits (ICs) this SRAM PUF provides a way of uniquely identifying the IC for hardware security.

As shown in FIG. 1A, the memory circuit 100 can include a memory array 102 having plural memory cells 104₁ to 104ₘ arranged in plural rows and plural columns (BL0 to BLN) (e.g., bit line columns). Each row is formed by a word line (WL) of plural word lines (WL0 to WLN), and each column is formed by a pair of bit lines (BLt and BLc) selected from plural bit lines. According to an exemplary embodiment, each memory cell 104 can include a pair of cross coupled inverters INV₁ and INV₂ that are connected between a pair of access transistors TR₁ and TR₂. The transistors can include any type of electronic switch configured to control the flow of current and a state of an associated memory cell. For example, the transistors can include a metal oxide semiconductor field effect transistor (MOSFET), a bipolar junction transistor (BJT), or any other suitable transistor as desired. Each access transistor TR is connected to one bit line of the pair of bit lines (BLt and BLc) forming a column at which the corresponding memory cell 104ₘ is located, and each access transistor TR has a gate TRG connected to the word line WL forming a row at which the corresponding memory cell 104ₘ is located.

The memory circuit 100 can include a decoder 106 configured to output a binary value for selecting a corresponding memory cell 104ₘ based on the pair of bit lines (BLt and BLc) and the word line WL to which the memory cell 104ₘ is connected. A sense amplifier SA is connected between the pair of bit lines (BLt and BLc) forming bit line column B1 (e.g., first column) of the plural bit line columns BL0 to BLN at within which a subset of the plural memory cells 104₁ to 104ₘ is arranged. The memory circuit 100 also includes a secondary sense amplifier (PUF-SA) connected between a first bit line (BLt) of the pair of bit lines (BLt and BLc) forming a second bit line column B0 of the plural bit line columns BLN and a first bit line (BLt) of the pair of bit lines (BLt and BLc) forming the first bit line column B1. According to an exemplary embodiment of the present disclosure, the first bit line column B1 and the second bit line column B0 are adjacent columns, and the secondary sense amplifier (PUF-SA) is configured to compare read current for bits of target memory cells in each of the adjacent columns.

The memory circuit 100 also includes a pre-charge circuit that is connected to a primary operating voltage (Vₒₚ) and to the pair of bit lines (BLt and BLc) in each column. The pre-charge circuit 108 is configured to charge each memory cell to the level or potential of the primary operating voltage Vₒₚ during a pre-charge phase. For example, during the response phase, the pre-charge circuit 108 is activated to pre-charge the bit lines (BLt, BLc) high for a specified bit line column BLN in the array, so that the word line WL of a corresponding row can be asserted and a pair of bit lines (BLt and BLc) of memory cells of the adjacent bit line column B1 can be evaluated by a secondary sense amp (PUF-SA).

The primary purpose of a cycle in an SRAM operation is to determine the state of the individual bit cell or bit. In known SRAM circuits, at startup, all bits in the memory array have either a “1” or “0” state. The start-up values create a random and repeatable pattern that is unique to each SRAM circuit. According to an exemplary embodiment of the present disclosure, for the challenge and response operation a predefined bit pattern is written to the array. To write a pattern of bits into the memory array, one of the pairs of bit lines (BLt and BLc) in a bit line column BLN associated with each memory cell is pulled (or written) high or low according to the pattern of bits being applied. That is, one of the pair of bit lines (BLt and BLc) forming the bit line column of a target memory cell is driven to either the primary operating voltage (Vₒₚ) or to ground potential, to write a 1 or 0, respectively, to the target memory cell 104ₘ. For example, if the desired bit pattern includes all zeroes (0s), then the bit line BLt for each column (BL0 to BLN) is pulled low or to ground potential, the BLc is held high, and the WL is asserted to write a 0 state to the cell. Each WL is asserted in sequence to write the entire array as desired the bits will be written consistent with the BLt/c values.

FIG. 1B shows an unfiltered read current mismatch distribution from an exemplary fully sampled 12-Mb die. As shown in Table I, the delta (BLt-BLc) data are normally distributed with a standard deviation (std dev) of 2.45 μA and have a mean of 83 nA.

TABLE I

| | | |
|---|---|---|
| WL location | Mean BLt-BLc | std dev BLt-BLc |

| | | | |
|---|---|---|---|
| adj | −1.45 | μA | 2.67 μA |
| adj + 1 | −78 | nA | 2.46 μA |
| no SPE | −46 | nA | 2.44 μA |
| (all) | −83 | nA | 2.45 μA |
| spice 10k MC | −43 | nA | 2.48 μA |

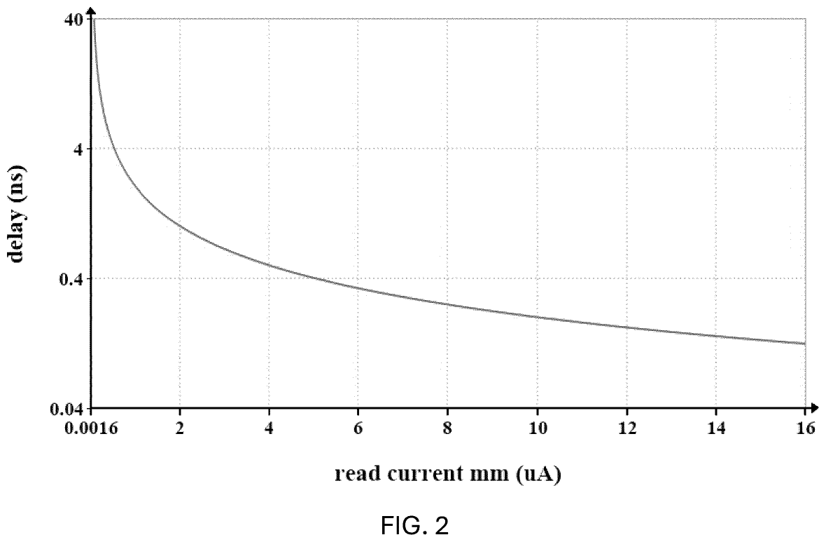

FIG. 2 illustrates a graph showing a resolution delay of a PUF SA in accordance with an exemplary embodiment of the present disclosure. According to exemplary embodiments disclosed herein, during a read verification test, the sense amplifier SA and the secondary sense amplifier PUF-SA are disabled. At the same time, each memory cell 104ₘ in the memory array 102 is activated in a specified sequence by activating a word line WL that is connected to the memory cell 104ₘ. According to an exemplary embodiment, the pre-charge circuit 108 is configured to pre-charge all bit lines in the array to a voltage level of the primary operating voltage (Vₒₚ). The pre-charge circuit 108 applies the primary operating voltage (Vₒₚ) to the word line WL forming the row associated with the target memory cell(s), so that the memory cell is enabled. The first bit line BLt in each of the first and second bit line columns is activated to select the secondary sense amplifier PUF SA in the adjacent bit line column. Because the pattern of bits written to the array is predefined, the read current for two adjacent (or near adjacent/local array) array bits can be sensed and compared. The secondary (PUF) sense amplifier is configured to output the binary (1 or 0) bit value of the PUF memory cell based on the activation of the first bit line BLt of the second bit line column B1. A verification circuit 110 is connected to the secondary sense amplifier and configured to determine whether current bit values stored in the adjacent memory cells are consistent with predefined bit values written to the adjacent memory cells based on the binary output. For example, a binary value of zero or near zero indicates that the read currents of the adjacent memory cells are substantially the same, whereas a binary value of one or near one indicates that the read currents are substantially different. Based on the predefined pattern of bits written to the memory cell array, the binary output of the secondary sense amplifier can verify the unique pattern or fingerprint of the SRAM PUF. According to an exemplary embodiment, the first bit line BLt of first bit line column B0 and the first bit line BLt of the second column are each a true bit line in the pair of bit lines when the array is blanket zeroes (0s). As shown in FIG. 2, the PUF SA resolution delay is only ˜6% and would be expected to exceed 4 ns using known state of the art CMOS technology as an example.

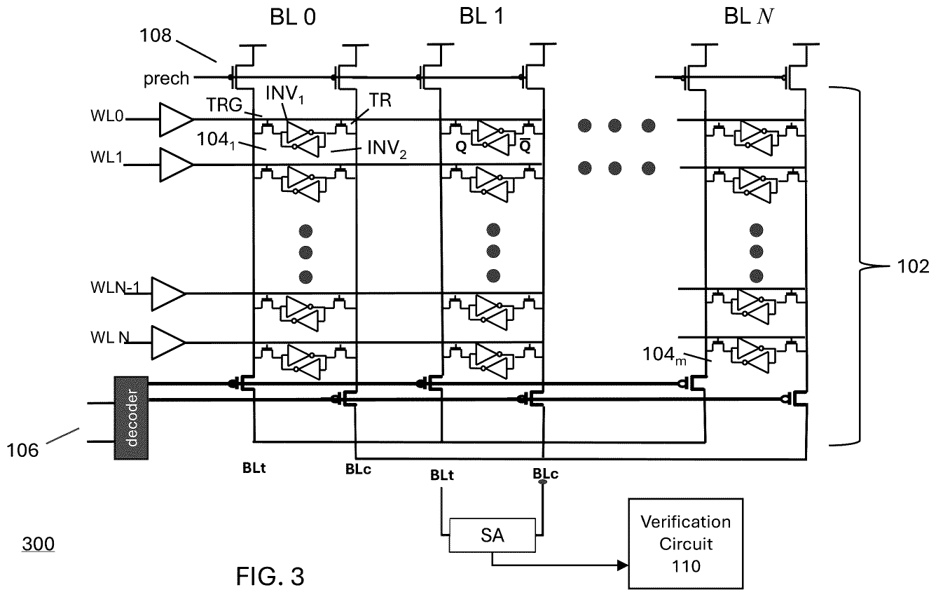

FIG. 3 illustrates a second memory circuit in accordance with an exemplary embodiment of the present disclosure. The memory circuit 300 shown in FIG. 3 is substantially similar to the circuit of FIG. 1, except for the omission of the secondary sense amplifier (PUF-SA). According to the exemplary embodiment of FIG. 3, for the challenge and response operation a predefined bit pattern is written to the array. For example, the predefined bit pattern can include alternating ones (1s) and zeroes (0s), such as a checkerboard pattern. During a read verification test, the sense amplifier SA is disabled and the pre-charge circuit 108 is configured to pre-charge the pair of bit lines BLt, BLc for each bit line column BL0 to BLN in the memory array to a voltage level or potential of the primary operating voltage (Vₒₚ). The memory cells in the array are activated in a scheme such that the word lines are activated in pairs. For example, the word lines WL_{N} and WL_{N-2} can be asserted simultaneously in an odd/even combination based on the predefined bit pattern, such that the memory cells which are activated have the same stored bit value. Next, a specified bit line column BLN of the plural columns is selected to compare two adjacent bits lines BLt and BLc in the selected bit line column BLN at the locations of the adjacent memory cells. The sense amplifier is enabled and the bit stored in a specified one of the adjacent memory cells is latched by the sense amplifier SA. A bit value of zero indicates that the read currents of the adjacent memory cells are substantially the same, whereas a bit value of one indicates that the read currents are substantially different. The latched bit is read and compared to the bit at a corresponding location in the predefined bit pattern. For example, the verification circuit 110 is connected to receive the latched bit from the sense amplifier SA and determine current bit values stored in the adjacent memory cells are consistent with predefined bit values written to the adjacent memory cells.

According to another exemplary embodiment a predetermined pattern of 1s and 0s can be realized based on a selection of one or more BL columns so that a selected pair of WLs cross the selected BL column(s) where the pattern of written bits are of opposite states. If for example, an alternating pattern of ones and zeros was written along a column, the 2 adjacent WLs could be asserted, or any odd/even pair of WLs along that column could be asserted. The primary SA would then be forced to resolve a 1 or 0 based on the competing read currents.

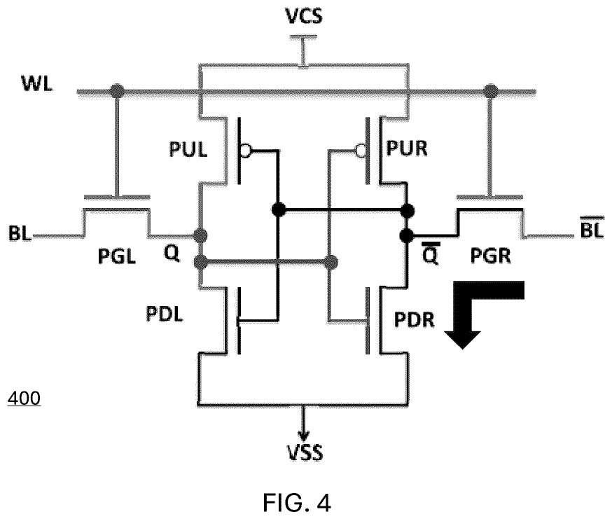

FIG. 4 illustrates a schematic of an SRAM circuit in accordance with an exemplary embodiment of the present disclosure. As shown in FIG. 4 wherein each inverter INV_{L} and INV_{R} in the pair of cross-coupled inverters includes a pull-up transistor PUL, PUR and a pull-down transistor PDL, PDR. According to an exemplary embodiment, the pull-up transistor PUL, PUR for each inverter INV_{L}, INV_{R} has an inverted gate terminal GT connected to a gate terminal of the pull-down transistor PDL, PDR, a source terminal SRC connected to the primary voltage source VCS, and a drain terminal DT connected to a drain terminal of one access transistor in the pair of access transistors PGL, PGR. The pull-down transistor PDL, PDR includes a source terminal connected to the drain terminal of the first access transistor PGL, PGR and a drain terminal connected to ground VSS. According to an exemplary embodiment, a first inverter INV_{L} in the pair of cross-coupled inverters, a source terminal of the access transistor PGL is connected to the true bit line BL (BLt) in the pair of bit lines BL, B̅L̅ (BLt, BLc). According to another exemplary embodiment, for a second inverter INV_{R} in the pair of cross-coupled inverters, a source terminal of the access transistor PGR is connected to a complementary bit line B̅L̅ (BLc) in the pair of bit lines (BLₜ, BL_{c}). The drain of the access transistor PGL of the first inverter INV_{L} is connected to the gate terminals of the pull-up transistor PDL and the pull-down transistor PDR of the second inverter INV_{R}. The drain of the access transistor PGR of the second inverter INV_{R} is connected to the gate terminals of the pull-up transistor PUL and the pull-down transistor PDL of the first inverter INV_{L}.

According to the exemplary circuit of FIG. 4, during a read cycle the pair of bit lines BL and B̅L̅ are pre-charged high, the word line WL is then asserted to at or near the operative voltage Vdd. As shown in FIG. 4 and according to an exemplary embodiment, the node Q is high and the node Q̅ is low, the access transistor PGR of the second inverter INV_{R} can be configured as an n-channel field effect transistor (NFET) having gate voltage Vgate determined by: Vgate−Vss=Vdd, which means that the n-channel is in a conducting state. Because B̅L̅ is initially high (at Vdd) the drain to source voltage (Vds) is initially equal to Vdd so that the access transistor PGR is initially in saturation mode. The PDR of the second inverter INV_{R} is initially in linear mode as Q̅ rises from near 0V to an intermediate voltage (Vn). For example, according to an exemplary embodiment of the present disclosure, Vn can be equal to approximately 0.15V for a 12 nm 0.8Vnom finFET technology. The read current path (arrow) results in a reduction in the voltage stored on the second bit line B̅L̅ compared to that of the first bit line BL, where the first bit line BL is not being actively pulled lower since the Vdrain-Vsource of the access transistor PGL of the first inverter INV_{L} is approximately 0V.

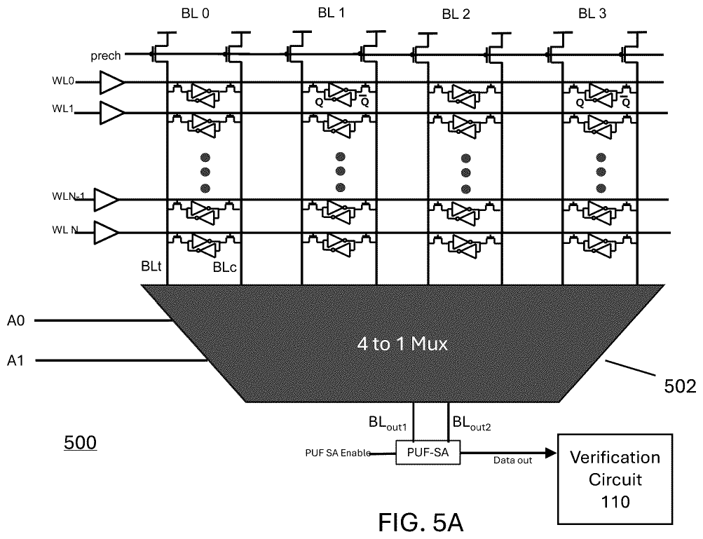

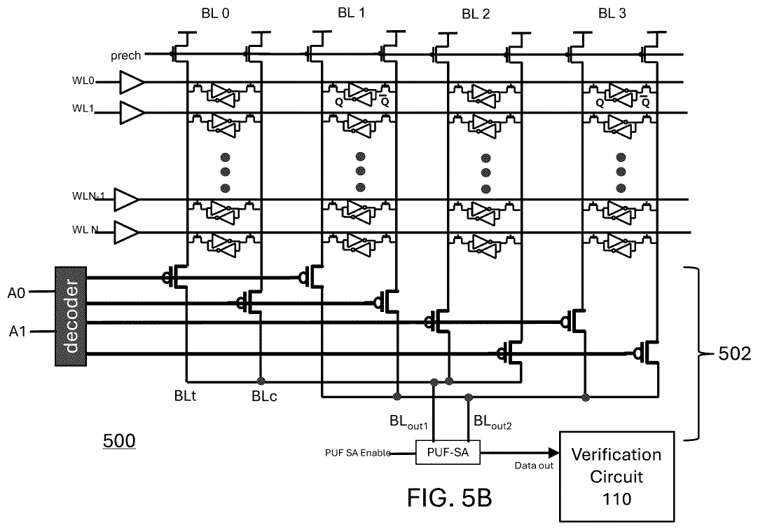

FIGS. 5A and 5B illustrate first schematic diagrams of a SRAM circuit with a multiplexer in accordance with an exemplary embodiment of the present disclosure. As shown in FIGS. 5A and 5B, the SRAM circuit 500 includes a multiplexer circuit 502. The multiplexer circuit 502 is configured with an input terminal TMᵢₙ connected to the plural pairs of bit lines BLt, BLc forming the plural columns BL0 to BLN. The multiplexer circuit 502 also includes a selection terminal A connected to receive a binary output of the decoder 404, and an output terminal A having a two bit lines BLₒᵤₜ₁, BLₒᵤₜ₂ connected to the secondary PUF sense amplifier SA (PUF SA). According to an exemplary embodiment, the memory array can be written to a predefined pattern of 1's and 0's, the multiplexer circuit 502 allows for two WL to be asserted concurrently, along with activation the secondary (PUF) sense amp PUF SA to compare the read currents of the two bit lines BL0t and BL1t, for example, consistent with the predefined pattern of ones and zeroes across the memory array 102. According to an exemplary embodiment, the multiplexer circuit 502 of FIGS. 5A and 5B allows for the comparison of read current for bit lines BL0 vs BL1, and BL2 vs BL3 for word lines WL₀ to WL_{N} after blanket zeroes (0s) or ones (1s) are written to the entire array. The SRAM circuit 500 is configured to compare the read current between two adjacent bit cells.

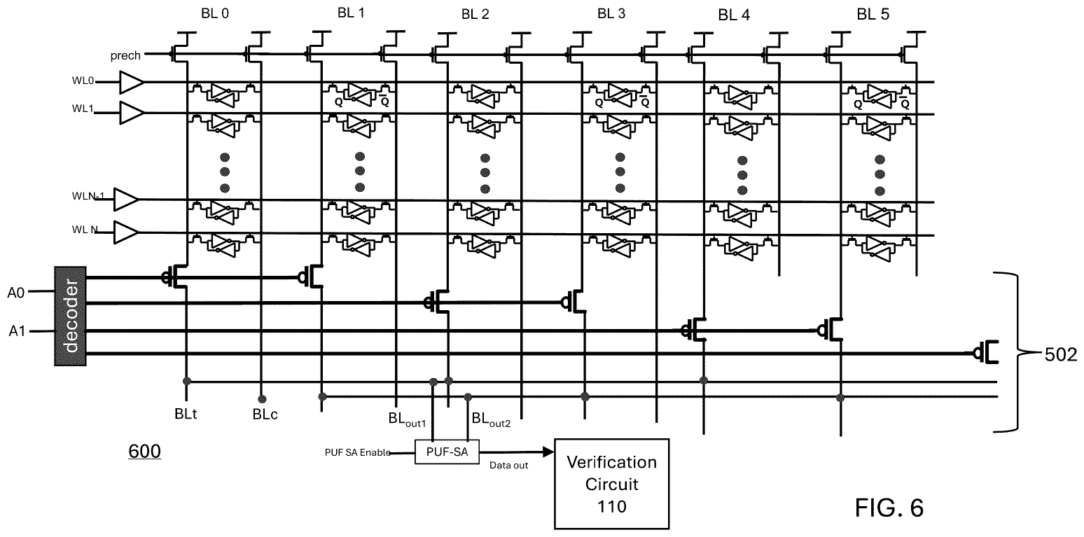

FIG. 6 illustrates a second schematic diagram of an SRAM circuit with a multiplexer in accordance with an exemplary embodiment of the present disclosure. As shown in FIG. 6, the multiplexer circuit 602 also includes a selection terminal A0, A1 connected to receive a binary output of the decoder 604, and an output terminal having a two bit lines BLₒᵤₜ₁, BLₒᵤₜ₂ connected to the secondary PUF sense amplifier SA (PUF SA). The circuit 406 differs from the multiplexer circuit 602 in that the bit lines BLt, BLc are connected such that a corresponding bit line of each bit line pair is connected to the same output terminal. For example, for each alternating bit line column BL0, BL2, BL4, etc., bit line BLt is connected to output terminal BLₒᵤₜ₁, and for each alternating column BL1, BL3, BL5, etc., bit line BLt is connected to output terminal BLₒᵤₜ₂. Based on this configuration, the multiplexer circuit 602 allows for the comparison of read current for bit lines BL0 vs BL1, BL2 vs BL3, BL4 vs BL5, and BL6 vs BL7 (not shown) for word lines WL0 to WLN after blanket zeroes are written to the entire array. The SRAM circuit 600 compares read current between two adjacent bit cells on the same word line WLx.

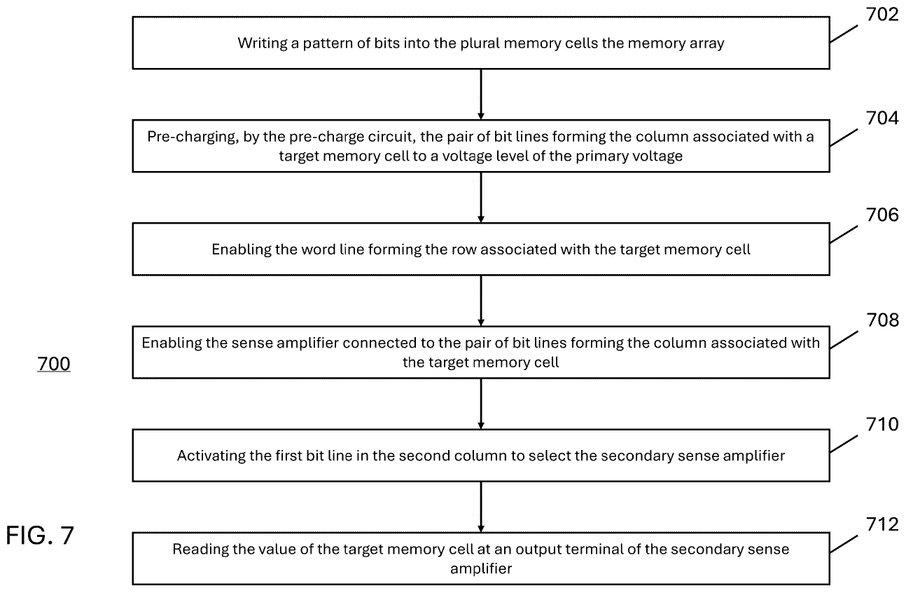

FIG. 7 illustrates a method 700 for authenticating an SRAM circuit of FIG. 1A in accordance with an exemplary embodiment of the present disclosure. As shown in step 702, a writing a pattern of bits is written into the plural memory cells the memory array. As discussed above, one of the pair of bit lines (BLₜ and BL_{c}) in a bit line column BLN associated with each memory cell is pulled high or low according to the pattern of bits being applied. That is, one of the pairs of bit lines (BLₜ and BL_{c}) forming the bit line column of the target memory cell is driven to either the primary operating voltage (Vₒₚ) or to ground potential, to write a 1 or 0, respectively, to the target memory cell. Next, the method 700 includes pre-charging, by the pre-charge circuit 108 all bit lines (BLₜ, BL_{c}) forming the columns BL0 to BLN associated with one or more target memory cells 104_{X} to a voltage level of the primary or operative voltage Vₒₚ (step 704). In step 706, the word line WL forming the row associated with the target memory cells 104_{X} is enabled. Next, step 708 includes enabling the sense amplifier SA connected to the pair of bit lines (BLt, BLc) forming the bit line column B1 associated with the target memory cell 104_{X}. Step 710 provides for activating the first bit line BLt, which is concurrent or the same for all bit lines in the memory array, in the second column BL0 to select the secondary sense amplifier PUF SA. The first bit line BLₜ in each of the first and second bit line columns BL1, BL0 is activated to select the secondary sense amplifier PUF SA in the adjacent bit line column BL0. Next, the value of the target memory cell 104_{X} is read at an output terminal of the secondary sense amplifier (step 712). The secondary (PUF) sense amplifier is configured to output the binary (1 or 0) bit value of the PUF memory cell 104_{X} based on the activation of the first bit line BLt of the second or adjacent bit line column BL0. As already discussed, the binary value measures a difference between the read currents of the adjacent memory cells. The verification circuit 110 receives the binary value determines whether current bit values stored in the adjacent memory cells are consistent with predefined bit values written to the adjacent memory cells (Step 714).

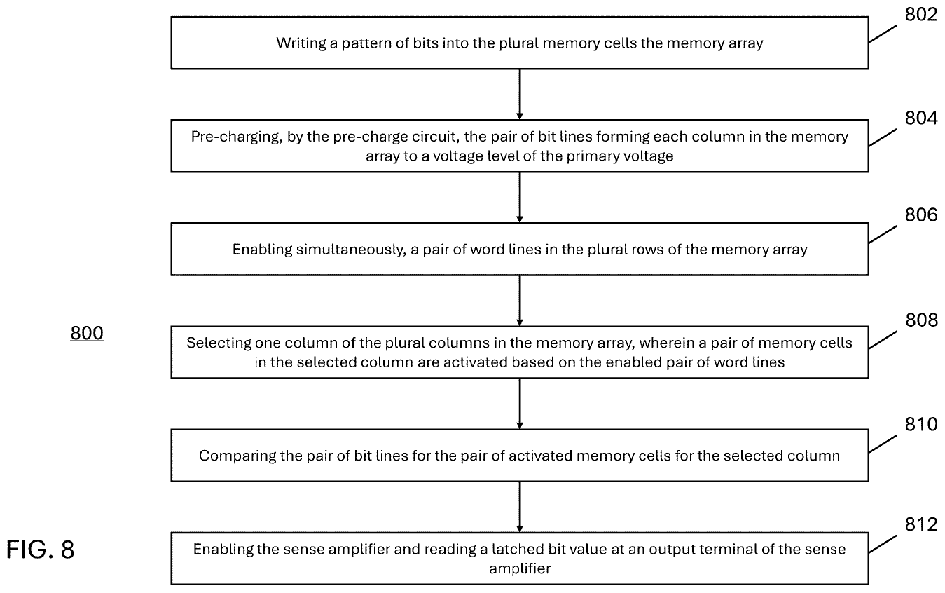

FIG. 8 illustrates a method 800 for authenticating an SRAM circuit of FIG. 3 in accordance with an exemplary embodiment of the present disclosure. At step 802, a pattern of bits is written into the plural memory cells the memory array. For example, the bits can be written to the memory array in a checkerboard pattern. Step 804 includes pre-charging, by the pre-charge circuit 108 the pair of bit lines (BLₜ, BL_{c}) forming each column BL0 to BLN in the memory array 102 to a voltage level of the primary or operative voltage Vₒₚ. At step 806, a pair of word lines WLN and WLN-2 of the plural rows in the memory array 102 are simultaneously enabled. Step 808 includes selecting one column BLN of the plural columns BL0 to BLN in the memory array 102 such that a pair of memory cells 104_{X}, 104_{X-2} in the selected column BLN are activated based on the enabled pair of word lines WLN and WLN-2. At step 810, the pair of bit lines BLt, BLc for the pair or activated memory cells 104_{X}, 104_{X-2} in the selected column BLN are compared. Next, the sense amplifier SA is enabled, and the latched bit is read at an output terminal of the sense amplifier SA (step 812). The verification circuit 110 receives the latched bit from the secondary sense amplifier and determines whether current bit values stored in the target memory cell is consistent with predefined bit value written to the target memory cell (Step 814).

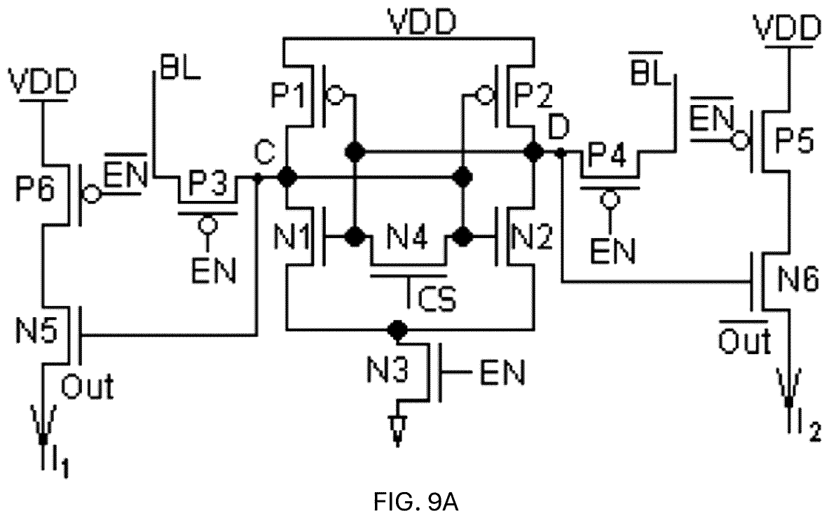

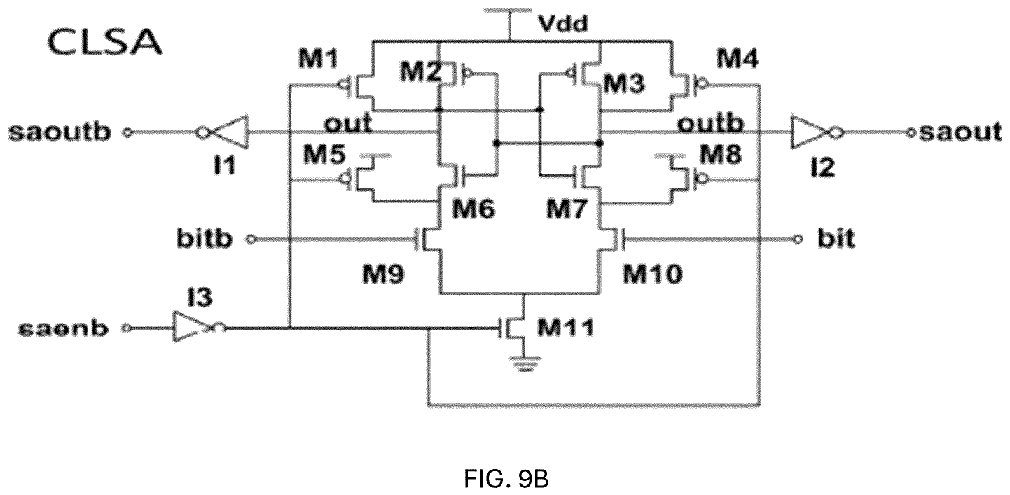

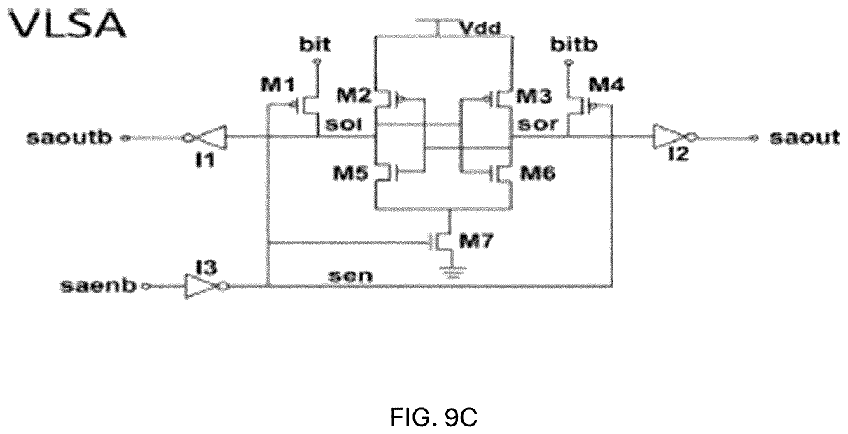

FIGS. 9A to 9C illustrate schematic diagrams of additional SRAM circuits in accordance with an exemplary embodiment of the present disclosure. As shown in FIG. 9A, an eleven transistor SRAM can include internal nodes C and D that are both high. The internal nodes are connected to the gates of output transistors N5 and N6, respectively and control the flow of current I1 and I2 during a write cycle when access transistors P3 and P4 are enabled by selection of the corresponding word line. FIG. 9B illustrates an exemplary SRAM circuit configured as a current-latched sense amplifier (CLSA). As shown in FIG. 9B, the circuit includes a first sense amplifier output terminal (saout) connected to the drain of pull up transistor M3 and the source of pull-down transistor M7 of a first of the cross-coupled inverters. The circuit also includes a second sense amplifier output terminal (saoutb) connected to the drain of the pull-up transistor M2 and the source of pull-down transistor M6. The circuit also includes a transistor M9, M10 connected to a drain of the pull-down transistor M6, M7 of each inverter circuit. The CLSA circuit is configured to provide an analog output voltage proportional to the current flowing into a load connected on its input. FIG. 9C illustrates an exemplary SRAM circuit configured as a voltage-latched sense amplifier (VLSA). The VLSA circuit can evaluate a small voltage difference applied at each input and convert it into a logic level output signal.

Exemplary embodiments of the present disclosure can be applied to and used in addressable memories such as DRAM, MRAM, and any other suitable addressable memory configuration that relies on a sense amp. The disclosed operation significantly expands the challenge-response pair space of the PUF converting it from a vulnerable PUF to a more robust PUF. The exemplary embodiments described herein are described in the context of SRAM however, it should be understood to the skilled artisan that sense amps and decoder circuitry of the present disclosure are applicable to other memory types (both embedded and stand-alone.

It will thus be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning, range, and equivalence thereof are intended to be embraced therein.

What is claimed is:

1. An integrated circuit, comprising:
a memory array having plural memory cells arranged in plural rows and plural bit line columns, each row is formed by a word line and each column is formed by a pair of bit lines, each memory cell including a pair of cross coupled inverters connected between a pair of access transistors, each access transistor is connected to one bit line of the pair of bit lines forming the bit line column, and each access transistor has a gate connected to the word line forming the row;
a pre-charge circuit configured to pre-charge the pair of bit lines for each bit line column in the memory array to a primary operating voltage;
a decoder configured to output a binary value for selecting each of the memory cells based on the pair of bit lines and the word line to which the memory cell is connected, the decoder being configured to assert a pair of word lines located in one of the plural bit line columns of the memory array to select a pair of adjacent memory cells;
a sense amplifier connected between the pair of bit lines forming a first column of the plural columns, the sense amplifier configured to generate a binary output based on a difference between read currents of the pair of adjacent memory cells; and
a verification circuit connected to receive the binary output from the sense amplifier and determine whether current bit values stored in the pair of adjacent memory cells are consistent with predefined bit values written to the pair of adjacent memory cells based on the binary output.

2. The integrated circuit of claim 1, comprising:
a secondary sense amplifier connected between a first bit line of the pair of bit lines forming a second column of the plural columns and a first bit line of the pair of bit lines forming the first column.

3. The integrated circuit of claim 2, wherein the verification circuit is configured to determine whether current bit values stored in an additional pair of adjacent memory cells associated with the secondary sense amplifier are consistent with predefined bit values written to the pair of adjacent memory cells based on the binary output.

4. The integrated circuit of claim 2, wherein the first column and the second column are adjacent columns in the plural columns of the memory array.

5. The integrated circuit of claim 1, wherein to write a pattern of bits into the memory array:
the sense amplifier is disabled;
each memory cell in the memory array is activated in a specified sequence by activating a word line connected to the memory cell;
wherein one of the pair of bit lines forming the column of the memory cell is driven to either the primary operating voltage or to a 0, to write a 0 or 1 to the memory cell.

6. The integrated circuit of claim 3, wherein the first bit line of first column and the first bit line of the second column are each a true bit line in the pair of bit lines when the array is blanket zeroes.

7. The integrated circuit of claim 6, wherein each inverter in the pair of cross-coupled inverters includes a pull-up transistor and a pull-down transistor,
wherein the pull-up transistor has an inverted gate terminal connected to a gate terminal of the pull-down transistor, a source terminal connected to the primary voltage source, and a drain terminal connected to a drain terminal of one access transistor in the pair of access transistors, and
wherein the pull-down transistor includes a source terminal connected to the drain terminal of the first access transistor and a drain terminal connected to ground.

8. The integrated circuit of claim 7, wherein for a first inverter in the pair of cross-coupled inverters, a source terminal of the access transistor is connected to the true bit line in the pair of bit lines,
wherein for a second inverter in the pair of cross-coupled inverters, a source terminal of the access transistor is connected to a complementary bit line in the pair of bit lines,
wherein the drain of the access transistor of the first inverter is connected to the gate terminals of the pull-up transistor and the pull-down transistor of the second inverter, and
wherein the drain of the access transistor of the second inverter is connected to the gate terminals of the pull-up transistor and the pull-down transistor of the first inverter.

9. The integrated circuit of claim 1, comprising:
a multiplexer circuit configured with an input terminal connected to the plural pairs of bit lines forming the plural columns, a selection terminal connected to receive a binary output of the decoder, and an output terminal having a two bit lines connected to the sense amplifier.

10. A method for authenticating an integrated circuit having a memory array that includes plural memory cells arranged in plural rows and plural columns, each row is formed by a word line and each column is formed by a pair of bit lines, each memory cell including a pair of cross coupled inverters connected between a pair of access transistors, each access transistor is connected to one bit line of the pair of bit lines forming the column, and each access transistor has a gate connected to the word line forming the row; a decoder configured to output a binary value for selecting each of the memory cells based on the pair of bit lines and the word line to which the memory cell is connected; a sense amplifier connected between the pair of bit lines forming a column of the plural columns; and a pre-charge circuit connected to a primary voltage and to the pair of bit lines in each column, the method comprising:
writing a pattern of bits into the plural memory cells the memory array;
pre-charging, by the pre-charge circuit, a pair of bit lines forming each column in the memory array to a voltage level of the primary voltage;
enabling a pair of word lines in the plural rows of the memory array;
selecting one column of the plural columns in the memory array, wherein a pair of memory cells in the selected column are activated based on the enabled pair of word lines;
comparing the pair of bit lines for the pair of activated memory cells for the selected column;
enabling the sense amplifier connected to the pair of bit lines forming the selected column;
reading a latched bit value at an output terminal of the sense amplifier; and
determining whether latched bit value is consistent with a predefined bit values written to the pair of activated memory cells based on the binary value output by the sense amplifier.

11. The method of claim 10, wherein the pattern of bits includes alternating ones and zeroes.

12. The method of claim 10, writing a pattern of bits to the plural memory cells comprises:
disabling the sense amplifier;
activating the word line connected to each memory cell in a specified sequence;
driving, for each activated memory cell, one of the pair of bit lines to ground potential and another of the pair of bit lines to the potential of the primary voltage; and
asserting the word line to the primary voltage to write a 0 or 1 to the memory cell, wherein the pair of bit lines are driven to zero potential and the potential of the primary voltage prior to the word line being asserted to the primary voltage.

13. The method of claim 12, wherein the word lines connected to each memory cell are activated in a specified sequence based on the pattern of bits.

14. The method of claim 10, wherein the integrated circuit includes a secondary sense amplifier connected between a first bit line of the pair of bit lines forming a second column of the plural columns and a first bit line of the pair of bit lines forming the first column, the method comprising:
determining whether latched bit value of the secondary sense amplifier is consistent with a predefined bit values written to a pair of activated memory cells of the second column based on the binary value output by the secondary sense amplifier.
